(19) United States
(12) Patent Application Publication
(10) Pub. No.: US 2025/0200478 A1
(43) Pub. Date: Jun. 19, 2025

(54) PROACTIVE SAFETY MANAGEMENT AND RISK PREDICTION SYSTEM USING MACHINE LEARNING

(71) Applicant: SAUDI ARABIAN OIL COMPANY, Dhahran (SA)

(72) Inventors: James Ohioma Arukhe, Dhahran (SA); Adai Onazi, Ras Tanura (SA)

(73) Assignee: SAUDI ARABIAN OIL COMPANY, Dhahran (SA)

(21) Appl. No.: 18/542,387

(22) Filed: Dec. 15, 2023

(51) Int. Cl. G06Q 10/0635

(52) U.S. Cl. CPC G06Q 10/0635

(57) ABSTRACT

A method for safety management and risk assessment in a work environment. The method includes obtaining data from a plurality of sources. The method further includes preprocessing, using a computer processor, the obtained data, where the preprocessing includes cleaning and normalizing the obtained data. The method further includes determining, using the computer processor and a machine learning model, a plurality of predictive variables based on the preprocessed data. The method further includes determining, using the computer processor and the machine learning model, risk exposure prioritization score based on the plurality of predictive variables. The method further includes determining, using the computer processor and the machine learning model, a plurality of safety recommendations based on the risk exposure prioritization score. The method further includes performing, in response to the safety recommendations and the risk exposure prioritization score, a maintenance operation on an equipment in the work environment.

### BACKGROUND

Traditional methods of identifying safety hazards and assessing risk exposures in a work environment often rely on manual analysis and human judgment, which may be time consuming and costly. In addition, these methods usually operate reactively, addressing safety incidents after they occur, rather than predicting and preventing them proactively. Generally, the traditional methods are also unable to handle large and complex volumes of data and fail to prioritize maintenance operations when operating conditions change. Accordingly, there exists a need to proactively identify safety hazards, assess risk exposures and prioritize maintenance operations to mitigate accidents in a work environment.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for safety management and risk assessment in a work environment. The method includes obtaining data from a plurality of sources. The data includes historical safety data, a plurality of incident reports, a plurality of operational parameters, a safety risk register, and a plurality of maintenance records. The method further includes preprocessing, using a computer processor, the obtained data, where the preprocessing includes cleaning and normalizing the obtained data. The method further includes determining, using the computer processor and a machine learning model, a plurality of predictive variables based on the preprocessed data. The method further includes determining, using the computer processor and the machine learning model, risk exposure prioritization score based on the plurality of predictive variables. The method further includes determining, using the computer processor and the machine learning model, a plurality of safety recommendations based on the risk exposure prioritization score. The method further includes performing, in response to the safety recommendations and the risk exposure prioritization score, a maintenance operation on an equipment in the work environment.

Embodiments disclosed herein generally relate to a non-transitory computer readable medium storing instructions executable by a computer processor. The instructions include functionality for obtaining data from a plurality of sources. The data includes historical safety data, a plurality of incident reports, a plurality of operational parameters, a safety risk register, and a plurality of maintenance records. The instructions further include functionality for preprocessing the obtained data, where the preprocessing includes cleaning and normalizing the obtained data. The instructions further include functionality for determining, using a machine learning model, a plurality of predictive variables based on the preprocessed data. The instructions further include functionality for determining, using the machine learning model, risk exposure prioritization score based on the plurality of predictive variables. The instructions further include functionality for determining, using the machine learning model, a plurality of safety recommendations based on the risk exposure prioritization score. The instructions further include functionality for performing, in response to the safety recommendations and the risk exposure prioritization score, a maintenance operation on an equipment.

Embodiments disclosed herein generally relate to a system. The system includes a plurality of sensors. The system further includes a safety management and risk assessment system including a computer processor, where the safety management and risk assessment system is coupled to the plurality of sensors. The safety management and risk assessment system includes functionality for obtaining data from the plurality of sensors. The data includes historical safety data, a plurality of incident reports, a plurality of operational parameters, a safety risk register, and a plurality of maintenance records. The safety management and risk assessment system further includes functionality for preprocessing the obtained data, where the preprocessing includes cleaning and normalizing the obtained data. The safety management and risk assessment system further includes functionality for determining, using a machine learning model, a plurality of predictive variables based on the preprocessed data. The safety management and risk assessment system further includes functionality for determining, using the machine learning model, risk exposure prioritization score based on the plurality of predictive variables. The safety management and risk assessment system further includes functionality for determining, using the machine learning model, a plurality of safety recommendations based on the risk exposure prioritization score. The safety management and risk assessment system further includes functionality for performing, in response to the safety recommendations and the risk exposure prioritization score, a maintenance operation on an equipment.

Other aspects and advantages of the claimed subject matter will be apparent from the following description and the appended claims.

### BRIEF DESCRIPTION OF DRAWINGS

FIG. 1 depicts a well system, in accordance with one or more embodiments.

FIG. 2 depicts a system, in accordance with one or more embodiments.

FIG. 3 depicts a flowchart, in accordance with one or more embodiments.

FIG. 4 depicts a system, in accordance with one or more embodiments.

FIG. 5 depicts a neural network, in accordance with one or more embodiments.

FIG. 6 depicts a system, in accordance with one or more embodiments.

FIG. 7A depicts performance metrics of a machine learning model during training and testing phases, in accordance with one or more embodiments.

FIG. 7B-7C depicts a visualization of actual and predicted incidents and equipment failures each month during an implementation of a machine learning model, in accordance with one or more embodiments.

FIG. 7D depicts actual and predicted incidents and equipment failures each month during an implementation of a machine learning model, in accordance with one or more embodiments.

FIG. 7E depicts performance metrics of a machine learning model during an implementation, in accordance with one or more embodiments.

FIG. 7F depicts a visualization of actual and predicted incidents and equipment failures each month during an implementation of a machine learning model, in accordance with one or more embodiments.

FIG. 8 depicts a flowchart, in accordance with one or more embodiments.

FIG. 9 depicts a computing system, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a “risk exposure prioritization score” may include any number of “risk exposure prioritization scores” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

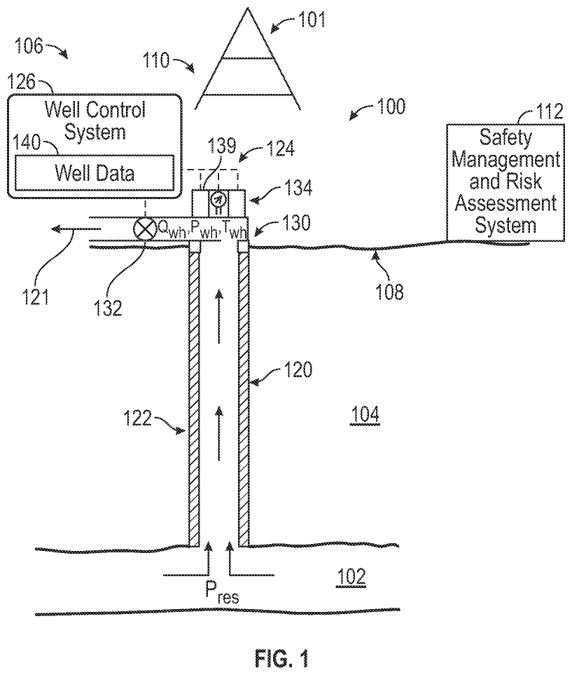

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Traditional methods of safety and risk management solutions often rely on manual analysis and human judgment. These solutions range from manual procedures, such as regular job safety analysis and process hazard analysis, to more automated approaches using rule-based systems and basic statistical models. Often, these procedures involve studying past incidents to improve safety protocols. While existing methods may be effective, they have several limitations because they fail to capture associated risks when operating conditions change. For example, traditional methods typically address safety incidents after they occur (i.e., reactively) rather than predicting and preventing them before they occur (i.e., proactively). Further, these methods often heavily rely on human judgment for risk assessment, which may be subject to errors, bias, and inconsistencies. Manual safety inspections, audits, and data analysis are also time-consuming and require significant human resources, thus leading to delays and increased costs. Importantly, due to the complexity and large volume of data involved, proactively predicting when equipment might need urgent maintenance is generally a difficult task. Therefore, determining what maintenance operations need to be prioritized within an organization is essential for strategic decision making.

Embodiments disclosed herein generally relate to methods and systems for proactively identifying safety hazards and risk exposures in a work environment. As will be described, these methods and systems use a machine learning model to determine a risk exposure prioritization score. Once trained, the machine learning model has learned how to determine risk exposure prioritization scores over a variety of situations (e.g., operational parameters and equipment conditions). In one or more embodiments, the trained machine learning model is used to provide safety recommendations. Further, in one or more embodiments, maintenance operations in the work environment are prioritized based on the safety recommendations and the risk exposure prioritization score. In another embodiment of the present invention, maintenance operations are performed, automatically, by the methods and systems of this disclosure, based on, at least, the risk exposure prioritization score determined using the machine learning model.

Machine learning, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), will be adopted herein, however, one skilled in the art will recognize that the concepts and methods detailed hereafter are not limited by this choice of nomenclature.

As discussed above, traditional methods for risk assessment and safety management often operate reactively, addressing safety incidents after they occur. This approach may lead to unnecessary risks and preventable incidents. Moreover, without the use of ML, traditional methods often have limited ability to predict future incidents based on existing data. Manual safety inspections, audits, and data analysis may also be time-consuming and require significant human resources, which may lead to delays and increased costs. Additionally, traditional methods often heavily rely on human judgment, which may be subject to errors, bias, and inconsistencies, and they may not leverage all available data (i.e., real-time operational parameters) for risk assessment and safety management. This may lead to missed opportunities for identifying risks and improving safety. Likewise, without the ability to learn from new data and improve over time, traditional methods may not adapt to changes in the operating environment or advances in safety practices. Further, these methods may also not effectively predict when equipment might need maintenance, potentially leading to equipment failures and associated safety incidents. These deficiencies may limit the effectiveness of prior art in managing safety and mitigating risks.

Embodiments of the present disclosure relate to the safety management and risk assessment system based on a ML model that proactively identifies safety hazards, predicts high risk scenarios following Failure mode and effect analysis (FMEA) principles, and provides data-driven actions to mitigate potential accidents. As such, embodiments disclosed herein overcome deficiencies of prior work in that they may predict potential safety hazards and high-risk scenarios before they occur, allowing for proactive safety measures and risk mitigation. Moreover, the system uses a wide range of data (e.g., historical safety data, incident reports, operational parameters, compliance reports, maintenance records, environmental conditions, safety equipment status) to make predictions. This data-driven approach may lead to more accurate and objective decisions than relying on human judgment alone. The system may also automatically analyze large amounts of data quickly and efficiently, saving time and resources compared to manual analysis.

Additionally, the system may also learn from new data and improve its predictions over time, leading to continuous improvement in safety and risk management. Further, the system may predict when equipment might need maintenance, helping to prevent equipment failures that could lead to safety incidents. Based on the predicted risks (e.g., based on a safety hazard identification, a risk exposure prioritization score, and trend score), the system may also suggest the most appropriate emergency response, aiding in emergency response planning. Further, the system may also provide recommendations (e.g., safety recommendations, predictive maintenance requirements, emergency response planning) for improving safety and mitigating identified risks, helping to improve safety standards.

Embodiments disclosed herein overcome deficiencies of prior work in that the ML model may also be integrated with existing safety and risk management systems, enhancing their capabilities, and providing a more comprehensive and data-driven approach to safety and risk management. This addresses the problem of integrating new technologies with existing systems. Moreover, the trend analysis capability of the system may identify patterns in the data over time, such as increasing risk in certain areas. This information may inform long-term safety planning and the continual refinement of risk management strategies, solving the problem of long-term safety planning. Likewise, the ML model may help identify complex patterns and relationships in the data that may not be detectable with traditional methods, allowing the system to predict potential safety hazards and high-risk scenarios with greater accuracy. Additionally, the ML model may also be easily scaled to handle larger amounts of data or more complex operations. This makes it suitable for large organizations that have extensive operations and vast amounts of data. As such, the safety management and risk assessment system in the present disclosure offers a more integrated, efficient, and effective approach to safety and risk management than prior art. Its advanced predictive capabilities, continuous learning, and data-driven recommendations make it a superior solution for improving safety and mitigating risks.

The versatility of the safety management and risk assessment system disclosed herein allows it to be adapted to a wide range of industries and applications, making it a valuable tool for organizations that prioritize safety and risk management. The system has a wide range of potential commercial applications across various industries. For example, the system may be used in manufacturing plants to predict potential safety hazards, plan maintenance schedules, and improve overall safety standards. In the construction industry, the system may help identify high-risk scenarios, enabling proactive safety measures and risk mitigation. Hospitals and other healthcare facilities may use the system to predict potential safety risks, such as patient falls or medication errors, and implement preventive measures. Airlines, shipping companies, and logistics providers may use the system to analyze safety data and operational parameters, predict potential safety incidents, and improve emergency response planning. In the energy sector, the system may be used to predict safety hazards related to equipment failure, extreme weather conditions, or other operational risks. Mining companies may use the system to predict safety risks related to equipment failure, geological conditions, or other operational parameters. Chemical plants may use the system to predict safety hazards related to chemical handling, equipment operation, and compliance with safety regulations. Government agencies may use the system for public safety applications, such as predicting traffic accidents or natural disasters, and planning emergency responses. Insurance companies may use the system to predict risk levels for different clients or scenarios, helping them to set premiums and make underwriting decisions more accurately. Car manufacturers may use the system to predict potential safety issues in the design and manufacturing process, helping to improve the safety of their vehicles. Pharmaceutical companies may use the system to predict safety risks in the drug development process, helping to improve the safety of their products. Retail businesses may use the system to predict safety hazards in their stores, such as potential for slips and falls, helping to improve customer safety. Food manufacturers and restaurants may use the system to predict safety risks related to food handling and preparation, helping to prevent foodborne illnesses. Environmental agencies may use the system to predict potential environmental hazards and plan appropriate mitigation measures. Tech companies may use the system to predict safety risks related to their products and services, thus helping to improve user safety. One with ordinary skill in the art will appreciate that many more examples exist and may be used without limiting the scope of the present disclosure.

The system's ability to analyze a wide range of data and predict potential safety hazards makes it applicable to any industry where safety and risk management are important. However, before practical application, several limitations need to be addressed. These include, for example, ensuring data quality and security, making the ML algorithms transparent and understandable, integrating the system with existing infrastructure, training users, and complying with relevant regulations. Overcoming these challenges will require both technical and organizational strategies.

FIG. 1 shows a schematic diagram in accordance with one or more embodiments. As shown in FIG. 1, a well environment (100) includes a hydrocarbon reservoir (“reservoir”) (102) located in a subsurface hydrocarbon-bearing formation (“formation”) (104) and a well system (106). The hydrocarbon-bearing formation (104) may include a porous or fractured rock formation that resides underground, beneath a geological surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102).

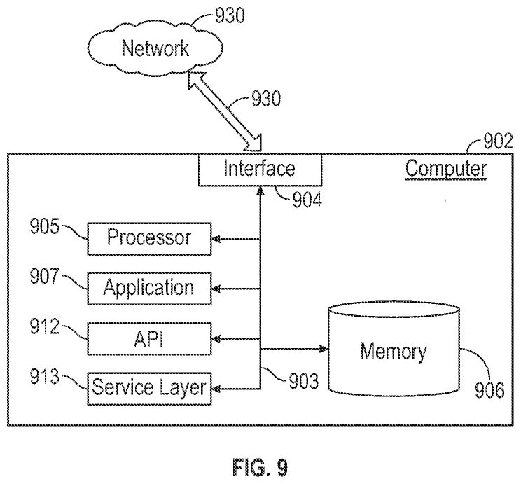

In some embodiments, the well system (106) includes a rig (101), a drilling system (110), a logging system (not shown), a safety management and risk assessment system (112), a wellbore (120), a well subsurface system (122), a well surface system (124), and a well control system (“control system”) (126). The drilling system (110) may include a drill string, a drill bit, and a mud circulation system for use in drilling the wellbore (120) into the formation (104). The logging system may include one or more logging tools, for use in generating well logs, based on the sensing system (134), of the formation (104). The well control system (126) may control various operations of the well system (106), such as well production operations, well drilling operation, well completion operations, well maintenance operations, and reservoir monitoring, assessment and development operations. In some embodiments, the well control system (126) includes a computer system that is the same as or similar to that of a computer system (902) described below in FIG. 9 and the accompanying description.

The rig (101) is a combination of equipment used to drill a borehole to form the wellbore (120). Major components of the rig (101) include the drilling fluid tanks, the drilling fluid pumps (e.g., rig mixing pumps), the derrick or mast, the draw works, the rotary table or top drive, the drill string, the power generation equipment and auxiliary equipment.

The wellbore (120) includes a bored hole (i.e., borehole) that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “downhole” end of the wellbore (120). The wellbore (120) may facilitate the circulation of drilling fluids during drilling operations, flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) lowered into the hydrocarbon-bearing formation (104) or the reservoir (102) during monitoring operations (e.g., during in situ logging operations).

In some embodiments, during operation of the well system (106), the well control system (126) collects and records well data (140) for the well system (106). The well control system (126) may include sensors for sensing characteristics of substances, including production (121), passing through or otherwise located in the well surface system (124). The sensor readings may include, at least, data about pressure, temperature, flow rate, and vibration. The sensor readings may be obtained using specialized tools such as, as least, thermometers, pressure gauges, and flowmeters (e.g., venturi meters, turbine meters, ultrasonic meters, electromagnetic meters, etc.). The well control system (126) may also include sensors for sensing characteristics of the rig (101), such as bit depth, hole depth, drilling fluid flow, hook load, rotary speed, etc. During drilling operation of the well (106), the well data (140) may include mud properties, pressure (P_{wh}), temperature (T_{WH}), flow rate (Q_{wh}), drill volume and penetration rates, formation characteristics, etc. In one or more embodiments, the flow rate Q_{wh} is measured by a flow rate sensor (139).

To drill a subterranean well or wellbore (120), a drill string (110), including a drill bit and drill collars to weight the drill bit, may be inserted into a pre-drilled hole and rotated to cut into the rock at the bottom of the hole, producing rock cuttings. Commonly, the drilling fluid, or drilling mud, may be utilized during the drilling process. To remove the rock cuttings from the bottom of the wellbore (120), drilling fluid is pumped down through the drill string (110) to the drill bit. The drilling fluid may cool and lubricate the drill bit and provide hydrostatic pressure in the wellbore (120) to provide support to the sidewalls of the wellbore (120). The drilling fluid may also prevent the sidewalls from collapsing and caving in on the drill string (110) and prevent fluids in the downhole formations from flowing into the wellbore (120) during drilling operations. Additionally, the drilling fluid may lift the rock cuttings away from the drill bit and upwards as the drilling fluid is recirculated back to the surface. The drilling fluid may transport rock cuttings from the drill bit to the surface, which may be referred to as “cleaning” the wellbore (120), or hole cleaning.

In some embodiments, the well data (140) are recorded in real time, or near real time, and are available for review or use within seconds, minutes or hours of the condition being sensed (e.g., the measurements are available within 1 hour of the condition being sensed). In such an embodiment, the well data (140) may be referred to as “real time” well data (140). Real time well data (140) may enable an operator of the well (106) to assess a relatively current state of the well system (106) and make real time decisions regarding a development of the well system (106) and the reservoir (102), such as on-demand adjustments in drilling fluid and regulation of production flow from the well.

In some embodiments, the well surface system (124) includes a wellhead (130). The wellhead (130) may include a rigid structure installed at the “up-hole” end of the wellbore (120), at or near where the wellbore (120) terminates at the geological surface (108). The wellhead (130) may include structures for supporting (or “hanging”) casing and production tubing extending into the wellbore (120). Production (121) may flow through the wellhead (130), after exiting the wellbore (120) and the well subsurface system (122), the well subsurface system including, for example, the casing and the production tubing. In some embodiments, the well surface system (124) includes flow regulating devices that are operable to control the flow of substances into and out of the wellbore (120). For example, the well surface system (124) may include one or more production valves (132) that are operable to control the flow of production (121). For example, a production valve (132) may be fully opened to enable the unrestricted flow of production (121) from the wellbore (120), the production valve (132) may be partially opened to partially restrict (or “throttle”) the flow of production (121) from the wellbore (120), and production valve (132) may be fully closed to fully restrict (or “block”) the flow of production (121) from the wellbore (120), and through the well surface system (124).

Keeping with FIG. 1, in some embodiments, the well surface system (124) includes a surface sensing system (134). The surface sensing system (134) may include sensors for sensing characteristics of substances, including production (121), passing through or otherwise located in the well surface system (124). The sensor readings may include, at least, data about pressure, temperature, flow rate, and vibration. The sensor readings may be obtained using specialized tools such as, as least, thermometers, pressure gauges, and flowmeters (e.g., venturi meters, turbine meters, ultrasonic meters, electromagnetic meters, etc.). The characteristics may include, for example, pressure (P_{wh}), temperature (T_{wh}) and flow rate (Q_{wh}) of production (121) flowing through the wellhead (130), or other conduits of the well surface system (124), after exiting the wellbore (120). The surface sensing system (134) may also include sensors for sensing characteristics of the rig (101), such as bit depth, hole depth, drilling fluid flow, hook load, rotary speed, etc.

In some embodiments, the wellhead (130) includes a choke assembly. For example, the choke assembly may include hardware with functionality for opening and closing the fluid flow through pipes in the well system (106). Likewise, the choke assembly may include a pipe manifold that may lower the pressure of fluid traversing the wellhead. As such, the choke assembly may include a set of high-pressure valves and at least two chokes. These chokes may be fixed or adjustable or a mix of both. Redundancy may be provided so that if one choke must be taken out of service, the flow may be directed through another choke. Effective control of the choke assembly prevents damage to equipment and promotes longer periods of production without shutdowns or interruptions. In some embodiments, pressure valves and chokes are communicatively coupled to the well control system (126). Accordingly, a well control system (126) may obtain wellhead data regarding the choke assembly as well as transmit one or more commands to components within the choke assembly to adjust one or more choke assembly parameters.

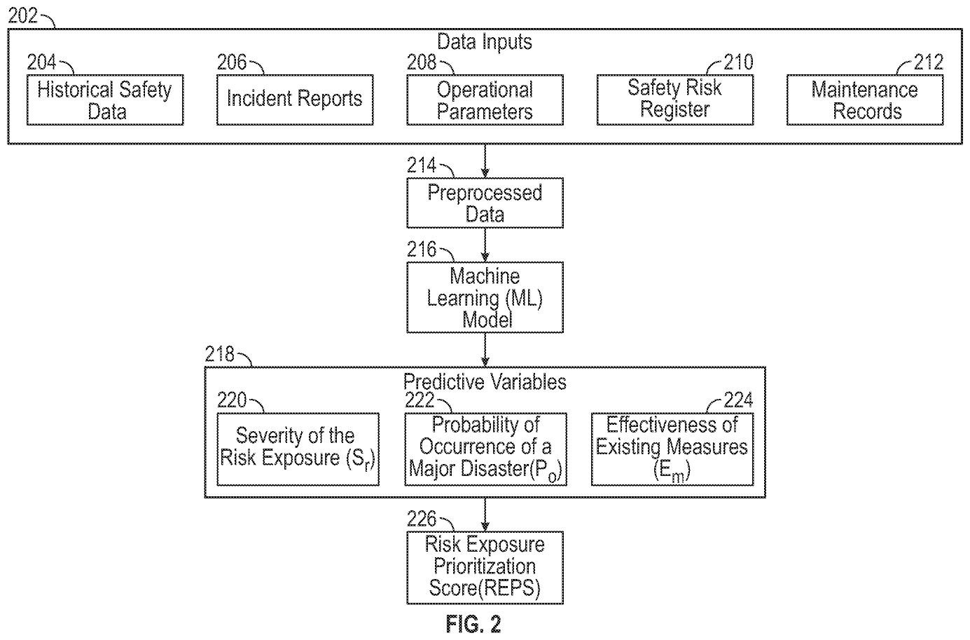

Failure mode and effect analysis (FMEA) is a systematic and methodical approach used in various industries to identify and mitigate potential failure modes in a process, system, or product. FMEA establishes an effective risk management environment and is performed to improve the reliability, safety, and quality of a product or process. While a full description of the steps required to conduct a FMEA exceeds the scope of this disclosure, it may simply be said that one of the steps involves calculating a risk exposure prioritization score(s) (REPS). In accordance with one or more embodiments, FIG. 2 depicts a flowchart which describes the process of developing and using a ML model to determine a REPS (226). Traditional FMEA uses the calculated REPS to evaluate the risk level of failures, to rank failures, and to prioritize action. In general, a higher REPS indicates a higher priority of failure.

In one aspect, embodiments disclosed herein relate to the safety management and risk assessment system (112) based on a ML model (216) that proactively identifies safety hazards, predicts high risk scenarios following FMEA principles, and provides data-driven actions to mitigate potential accidents, as discussed in greater detail below. In accordance with one or more embodiments, the safety management and risk assessment system (112) and ML model (216) prioritize maintenance operations based on the REPS. This proactive, FMEA-compliant approach improves upon traditional methods by utilizing data more effectively, eliminating the bias of human judgment, and offers predictive capabilities. In addition, it allows organizations to implement safety measures and mitigate risk ahead of time, fostering a safer work environment and a more efficient resource allocation.

In some embodiments, the well system (106) includes the safety management and risk assessment system (112). For example, the safety management and risk assessment system (112) may include hardware and/or software with functionality for generating REPS (226) and automatically performing maintenance operations (612). For this purpose, the system may include memory with one or more data structures, such as a buffer, a table, an array, or any other suitable storage medium. In some embodiments, the safety management and risk assessment system (112) may include a computer system similar to the computer system (902) described below with regard to FIG. 9 and the accompanying description. While the safety management and risk assessment system (112) is shown at a well site in FIG. 1, in some embodiments, the safety management and risk assessment system (112) may be located remotely from well site.

As will be described later in the instant disclosure, once the ML model (216) has been trained it may be used “in production”, which means a trained ML model (600) is used to process a received input without having a paired target for comparison, to provide safety recommendations (602) based on which maintenance operations (612) are automatically performed on equipment (e.g., the choke assembly of FIG. 1) in the work environment (e.g., the well environment (100)).

Initially, data inputs (202) obtained from a plurality of sources are preprocessed to obtain preprocessed data (214) and are received by the ML model (216). The plurality of sources includes a plurality of internal and external databases, a plurality of sensors, a plurality of manual reports, a plurality of distributed control systems, and a plurality of engineering workstations. Generally, and as will be described later in the instant disclosure, preprocessing comprises, at a minimum, altering the data inputs (202) so that they are suitable for use with ML models. In accordance with one or more embodiments, the data inputs (202) may include historical safety data (204), incident reports (206), operational parameters (208), a safety risk register (210), and maintenance records (212). For example, historical safety data (204) may include past records of safety related incidents and incident reports (206) may include detailed accounts of previous incidents. Operational parameters (208) may include process upsets, system alarms, choke assembly parameters, pressure and temperature data (e.g., pressure and temperature data as determined by the surface sensing system (134)). In one or more embodiments, the incident reports (206), operational parameters (208) and maintenance records (212) may be obtained in real time or near real time. In other embodiments, the incident reports (206), operational parameters (208) and maintenance records (212) may be obtained sequentially or immediately after drilling operations are performed. Further, a safety case register (210), defined as a database with information relevant to a hazard, may include hazard and operability studies, safety integrity levels, quantitative risk assessments, an operations integrity management system, and safety regulations and standards. Maintenance records (212) may include information on equipment maintenance and inspections.

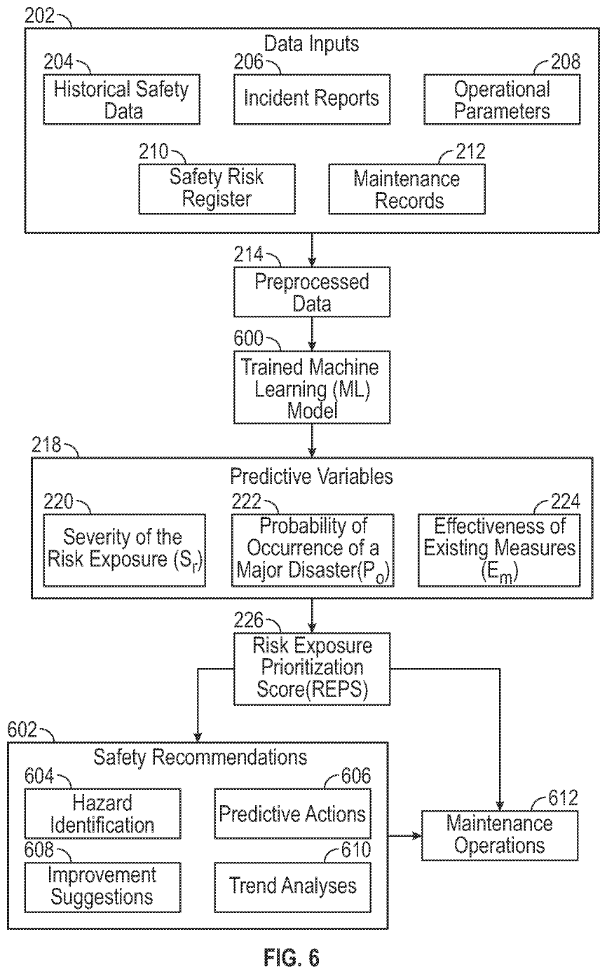

In accordance with one or more embodiments, after preprocessing the data inputs (202) to obtain preprocessed data (214), the preprocessed data (214) is inputted into the ML model (216) and the ML model (216) outputs predictive variables (218). These variables may include, for example, severity of the risk exposure (220), probability of occurrence of a major disaster (222) and effectiveness of existing measures (224). Severity of the risk exposure (220) is an assessment of the effect of potential failure mode to the next component, subsystem, or customer. This variable measures the seriousness of the consequences of a failure, assuming it occurs. The probability of occurrence of a major disaster (222) is defined as the likelihood that a specific safety event may occur. For example, in one or more embodiments, a safety event in an oil and gas field may include blowouts, gas leaks and equipment failure. Effectiveness of existing measures (224) is an assessment of the ability of current design controls to detect or prevent a potential safety event before it occurs. This variable is a key component of FMEA, focusing on the detection and prevention capabilities of current safety measures. In traditional FMEA, these three factors are often subjectively estimated by experts in accordance with a scale from 1 to 10, based on commonly agreed evaluation criteria. However, in the present invention, these variables are determined using a trained ML model, as will be described in greater detail later in FIG. 6. Embodiments disclosed herein enable a significant advancement in the application of FMEA principles, leveraging data-driven approaches for more objective and potentially accurate risk assessments and prevention of major disasters.

In one or more embodiments, a REPS (226) may be determined using the predictive variables (218). The REPS (226) is a measure of the risk of failures, and it may be used to rank failures and prioritize actions. In general, a higher REPS indicates a higher priority of failure. Therefore, failures with the highest REPS (226) may be given the highest priority. Mathematically, the REPS (226) is given by:

$$REPS = {S}_{r} \times {P}_{0} \times {E}_{m} \qquad Equation ( 1 )$$

where Sᵣ is the severity of the risk exposure (220), P₀ is the probability of occurrence of a major disaster (222), and Eₘ is the effectiveness of existing measures (224). When there are multiple exposures, the ML model (216) calculates the total exposure (REPSₜₒₜₐₗ) as the sum of the individual REPS:

$$R E P {S}_{total} = R E P {S}^{1} + R E P {S}^{2} + … + R E P {S}^{N} \qquad Equation ( 2 )$$

where N is the total number of exposures.

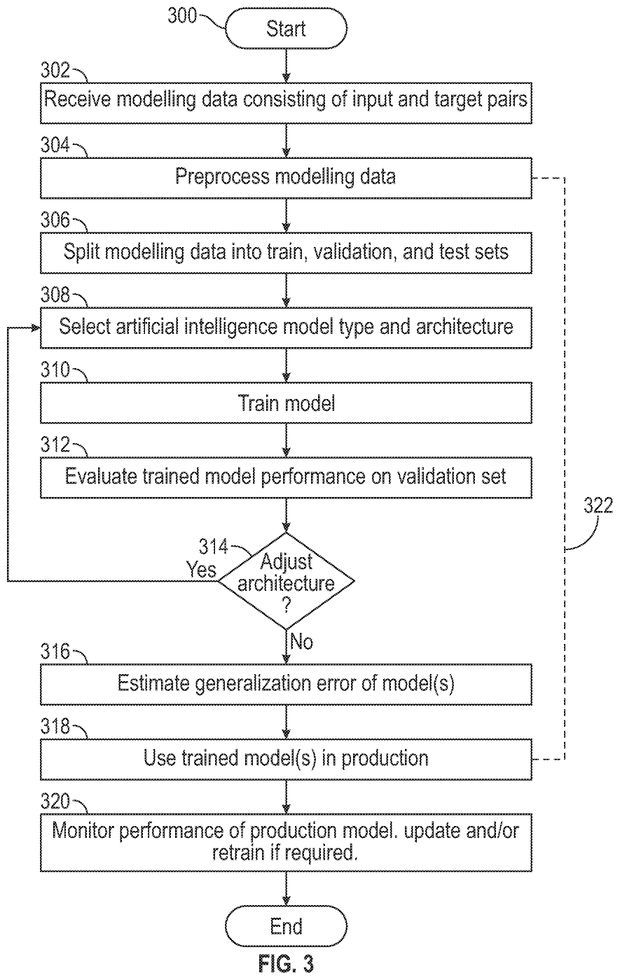

FIG. 3 depicts the general process of selecting and training the ML model, in accordance with one or more embodiments. The process shown in FIG. 3 may be applied to obtain the trained ML model (600). To start, as shown in Block 302, modelling data is received. The modelling data consists of input and target pairs. For example, to train the ML model (216), an input and target pair may consist of data inputs (202) and the predictive variables (218). In accordance with one or more embodiments, the data inputs (202) may include historical safety data (204), incident reports (206), operational parameters (208), a safety risk register (210), and maintenance records (212). Operational parameters (208) may include process upsets, system alarms, choke assembly parameters, pressure and temperature data. In one or more embodiments, the pressure and temperature data are collected using a surface sensing system (134) appropriately disposed at one or more locations on the surface (108) section or obtained from previously collected historical well data.

Returning to FIG. 3, in one or more embodiments, the modelling data is preprocessed as depicted by Block 304. As previously stated, preprocessing comprises, at a minimum, altering the modelling data so that it is suitable for use with ML models. For example, preprocessing may include numericizing categorical data or removing data entries with missing values. Other typical preprocessing methods are normalization and subsampling. Subsampling is a method that reduces data size by selecting a subset of the original data. In general, information surrounding the preprocessing steps is saved for potential later use. For example, if normalization is performed then a computed mean vector and variance vector are retained. This allows future modelling data to be preprocessed identically. Values computed and retained during preprocessing are referred to herein as preprocessing parameters. One with ordinary skill in the art will recognize that a myriad of preprocessing methods beyond numeration, removal of modelling data entries with missing values, normalization, and subsampling exists. Descriptions of a select few preprocessing methods herein do not impose a limitation on the preprocessing steps encompassed by this disclosure.

As shown in Block 306, the modelling data is split into training, validation, and test sets. In some embodiments, the validation and test set may be the same and the data is effectively only split into two distinct sets. In some instances, Block 306 may be performed before Block 304. In this case, it is common to determine the preprocessing parameters, if any, using the training set and then to apply these parameters to the validation and test sets.

In Block 308, the ML model type and associated architecture is selected. Once selected, the ML model is trained using the training set of the modelling data according to Block 310. Common training techniques, such as early stopping, adaptive or scheduled learning rates, and cross-validation may be used during training without departing from the scope of this disclosure.

ML model types may include, but are not limited to, K-means clustering, K-nearest neighbors, neural networks, logistic regression, random forests, generalized linear models, and Bayesian regression. Also, ML encompasses model types that may further be categorized as “supervised”, “unsupervised”, “semi-supervised”, or “reinforcement” models. One with ordinary skill in the art will appreciate that additional or alternate ML model categorizations may be defined without departing from the scope of this disclosure. Constraining a model to make it simpler and reduce the risk of overfitting is called regularization. The amount of regularization to be applied during learning may be controlled by “hyperparameters” which further describe the ML model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a model is referred to as selecting the model “architecture”. Generally, multiple model types and associated hyperparameters are tested and the model type and hyperparameters that yield the greatest predictive performance on a hold-out set of data is selected. Greater detail regarding the ML models, in accordance with one or more embodiments, will be provided below in the present disclosure.

During training, or once trained, the performance of the trained ML model is evaluated using the validation set as depicted in Block 312. Recall that, in some instances, the validation and test sets are the same. Generally, performance is measured using a function which compares the predictions of the trained ML model to the given targets. A commonly used comparison function is the mean-squared-error function, which quantifies the difference between the predicted value and the actual value when the predicted value is continuous. However, one with ordinary skill in the art will appreciate that many more comparison functions exist and may be used without limiting the scope of the present disclosure.

Block 314 represents a decision: if the trained ML model performance, as measured by a comparison function on the validation set (Block 312), is not suitable, the ML model architecture may be altered (i.e., return to Block 308) and the training process is repeated. There are many ways to alter the ML model architecture in search of suitable trained ML model performance. These include, but are not limited to: selecting a new architecture from a previously defined set; randomly perturbing or randomly selecting new hyperparameters; using a grid search over the available hyperparameters; and intelligently altering hyperparameters based on the observed performance of previous models (e.g., a Bayesian hyperparameter search). Once suitable performance is achieved, the training procedure is complete, and the generalization error of the trained ML model is estimated according to Block 316.

Generalization error is an indication of the trained ML model's performance on new, or un-seen data. Typically, the generalization error is estimated using the comparison function, as previously described, using the modelling data that was partitioned into the test set.

As depicted in Block 318, the trained ML model is used “in production”, which means, as previously stated, that the trained ML model is used to process a received input without having a paired target for comparison. It is emphasized that the inputs received in the production setting, as well as for the validation and test sets, are preprocessed identically to the manner defined in Block 304 as denoted by the connection (322), represented as a dashed line in FIG. 3, between Blocks 318 and 304.

In accordance with one or more embodiments, the performance of the trained ML model is continuously monitored in the production setting (320). If model performance is suspected to be degrading, as observed through in-production performance metrics, the model may be updated. An update may include retraining the model, by reverting to Block 308, with the newly acquired modelling data from the in-production recorded values appended to the training data. An update may also include recalculating any preprocessing parameters, again, after appending the newly acquired modelling data to the existing modelling data.

While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Gradient boosting is an ensemble learning method used in ML that creates a predictive model by combining the predictions of several multiple “weak” learners to create a “strong” predictive model. The basic idea behind a gradient boosting algorithm is to iteratively add learners to correct the errors of the previous learners in the ensemble. At each iteration, a new “weak” learner model is trained with respect to the error of the entire ensemble. The goal of the algorithm is to find a function F(x) that best approximates the target variable (e.g., a REPS (226)) from the input variables (e.g., historical safety data (204), incident reports (206), operational parameters (208), a safety risk register (210), and maintenance records (212)), such that ŷ=F(x).

While a full review of gradient boosting exceeds the scope of this disclosure, a brief summary is provided. Consider a training set {(xᵢ, rᵢₘ)}ᵢ₌₁ⁿ, a differentiable loss function L(yᵢ, F(xᵢ)), and a gradient boosting algorithm with M stages. The predicted REPS for the i-th observation at the m-th stage is denoted as Fₘ(xᵢ). The algorithm starts by initializing the model with a constant value γ:

$$1 ) {F}_{0} ( x ) = {arg min}_{γ} {\sum }_{i = 1}^{n} L ( {y}_{i} , γ ) \qquad ( Equation 3 )$$

where the term “arg min” is a mathematical notation that represents the value of γ at which the minimum value of Σᵢ₌₁ⁿ(yᵢ, γ) is achieved. For example, for a mean-squared-error loss function the initial model predicts F₀(x)=1/nΣᵢ₌₁ⁿyᵢ, i.e., the mean of the target values.

At each subsequent m=1 to m=M stage, the algorithm computes the pseudo-residuals:

$${r}_{i m} = - {[ \frac{\partial L ( {y}_{i} , F ( {x}_{i} ) )}{\partial F ( {x}_{i} )} ]}_{F ( x ) = {F}_{m - 1} ( x )} , for i = 1 , … , n \qquad ( Equation 4 )$$

For example, for a mean-squared-error loss function the pseudo-residuals rᵢₘ are the difference between the target and predicted REPS (i.e., rᵢₘ=yᵢ−Fₘ₋₁).

Further, the algorithm fits a base learner (e.g., a decision tree) hₘ(x) to the pseudo-residuals. In other words, the base learner is trained using the {(xᵢ,rᵢₘ)}ᵢ₌₁ⁿ set and chooses a multiplier γₘ that minimizes the loss function when added to the current model:

$${γ}_{m} = {arg min}_{γ} {\sum }_{i = 1}^{n} L ( {y}_{i} , {F}_{m - 1} ( {x}_{i} ) + γ {h}_{m} ( {x}_{i} ) ) \qquad ( Equation 5 )$$

$$The model is updates as follows : \qquad ( Equation 6 )$$

$${F}_{m} ( x ) = {F}_{m - 1} ( x ) + {γ}_{m} {h}_{m} ( x )$$

$$The output of the algorithm is : \qquad ( Equation 7 )$$

$${F}_{M} ( x ) = {F}_{0} ( x ) + {γ}_{1} {h}_{1} ( x ) + … + {γ}_{M} {h}_{M} ( x )$$

Gradient boosting may be extended to include subsampling and regularization to improve the model's performance and prevent overfitting. Subsampling is a technique where a subset of the data is randomly selected at each iteration before fitting the base learner. This may improve performance and help prevent overfitting by adding randomness into the model building process. Regularization is a technique used to prevent overfitting by adding a penalty term to the loss function that discourages complex models. In the context of gradient boosting, regularization is often applied by shrinking the predictions of each base learner by a factor of 0<λ≤1 and by limiting the complexity of the base learners. The gradient boosting algorithm with subsampling and regularization starts with initializing the model with a constant value γ:

$${F}_{0} ( x ) = {arg min}_{γ} {\sum }_{i = 1}^{n} L ( {y}_{i} , γ ) \qquad ( Equation 8 )$$

Further, for at each subsequent m=1 to m=M stage, a subsample Sₘ is drawn without replacement from the training data and the pseudo-residuals for the subsample Sₘ are computed as follows:

$${r}_{i m} = - {[ \frac{\partial L ( {y}_{i} , F ( {x}_{i} ) )}{\partial F ( {x}_{i} )} ]}_{F ( x ) = {F}_{m - 1} ( x )} , for i in {S}_{m} \qquad ( Equation 9 )$$

A base learner (e.g., a decision tree) hₘ(x) is fitted to the pseudo-residuals and a multiplier γₘ is chosen so that it minimizes the loss function when added to the current model:

$${γ}_{m} = {arg min}_{γ} {\sum }_{i = 1}^{n} L ( {y}_{i} , {F}_{m - 1} ( {x}_{i} ) + γ {h}_{m} ( {x}_{i} ) ) \qquad ( Equation 10 )$$

The model is updated by shrinking the predictions of each base learner by a factor λ:

$${F}_{m} ( x ) = {F}_{m - 1} ( x ) + {γ}_{m} {h}_{m} ( x ) \qquad ( Equation 11 )$$

The output of the algorithm is:

$${F}_{M} ( x ) = {F}_{0} ( x ) + {γ}_{1} {h}_{1} ( x ) + … + {γ}_{M} {h}_{M} ( x ) \qquad ( Equation 12 )$$

In this version of the algorithm, each base learner is fit to a random subsample of the data, and the predictions of each base learner are shrunk by a factor of λ. This may help to improve the model's performance and prevent overfitting.

In some embodiments, the selected ML model type is a gradient boosted trees classifier. Generally, a gradient boosted trees classifier is an ensemble of decision trees. A decision tree is composed of nodes. A decision is made at each node such that data present at the node are segmented. Typically, at each node, the data at said node, are split into two parts, or segmented bimodally, however, multimodal segmentation is possible. The segmented data may be considered another node and may be further segmented. As such, a decision tree represents a sequence of segmentation rules. The segmentation rule (or decision) at each node is determined by an evaluation process. The evaluation process usually involves calculating which segmentation scheme results in the greatest homogeneity or reduction in variance in the segmented data. A detailed description of this evaluation process, or other potential segmentation scheme selection methods, is omitted for brevity and does not limit the scope of the present disclosure.

Further, if at a node in a decision tree, the data are no longer to be segmented, that node is said to be a “leaf node”. Commonly, values of data found within a leaf node are aggregated, or further modeled, such as by a linear model, so that a leaf node represents a class. The class of a leaf node will hereinafter be referred to as the assigned class of the leaf node. A decision tree may be configured in a variety of ways, such as, but not limited to, choosing the segmentation scheme evaluation process, limiting the number of segmentations, and limiting the number of leaf nodes. Generally, when the number of segmentations or leaf nodes in a decision tree is limited, the decision tree is said to be a “weak learner.” In most implementations, the decision trees from which a gradient boosted trees classifier is composed are “weak” learners. Additionally, for a gradient boosted trees classifier, the decision trees are ensembled in series, wherein each decision tree makes a weighted adjustment to the output of the preceding decision trees in the series. The process of ensembling decision trees in series, and making weighted adjustments, to form a gradient boosted trees classifier is best illustrated by considering the training process of a gradient boosted trees classifier.

The following description of the gradient boosted trees training process assumes that properly formatted training data (after normalization, subsampling, etc.), which contains both the data inputs (202) and the desired output data (or target data, or “targets”) (e.g., predictive variables (218)), are supplied. Training a gradient boosted trees classifier consists of the selection of segmentation rules for each node in each decision tree; that is, training each decision tree. Once trained, a decision tree is capable of processing data. For example, a decision tree may receive a data input (202). The data input is sequentially transferred to nodes within the decision tree according to the segmentation rules of the decision tree. Once the data input is transferred to a leaf node, the decision tree outputs the assigned class of the associated leaf node.

Generally, training a gradient boosted classifier consists of making a simple prediction (SP) for the target data. The SP may the most frequent class of the target data, or the log odds or cross-entropy of the frequency of classes in the target data. The SP is subtracted from the targets to form a first residuals. The first decision tree in the series is created and trained, wherein the first decision tree attempts to predict the first residuals forming first residual predictions. The first residual predictions from the first decision tree are scaled by a scaling parameter. In the context of gradient boosted trees, the scaling parameter is known as the “learning rate” (η). In general, as previously stated, constraining a model to make it simpler and reduce the risk of overfitting is called regularization. The amount of regularization to be applied during learning may be controlled by “hyperparameters”. The learning rate is one of the hyperparameters governing the behavior of the gradient boosted trees regressor. The learning rate (η) may be fixed for all decision trees or may be variable or adaptive. The first residual predictions of the first decision tree are multiplied by the learning rate (η) and added to the SP to form a first predictions. The first predictions are subtracted from the targets to form a second residuals. A second decision tree is created and trained using the data inputs and the second residuals as targets such that it produces second residual predictions. The second residual predictions are multiplied by the learning rate (η) and are added to the first predictions forming second predictions. This process is repeated recursively until a termination criterion is achieved. Many termination criteria exist and are not all enumerated here for brevity. Common termination criteria terminate training when a pre-defined number of decision trees has been reached, or when improvement in the residuals is no longer observed.

Once trained, a gradient boosted trees classifier may make predictions using data inputs (202). To do so, the data inputs (202) are passed to each decision tree, which will form a plurality of residual predictions. The plurality of residual predictions is multiplied by the learning rate (η), summed across every decision tree, and added to the SP formed during training to produce the gradient boosted trees predictions. In some instances, a conversion is required to convert the output of the gradient boosted trees prediction to a class assignation.

One with ordinary skill in the art will appreciate that many adaptions may be made to gradient boosted trees and that these adaptions do not exceed the scope of this disclosure. Some adaptions may be algorithmic optimizations, efficient handling of sparse data, use of out-of-core computing, and parallelization for distributed computing. In accordance with one or more embodiments, the selected ML model type is an adapted gradient boosted trees model known as XGBoost.

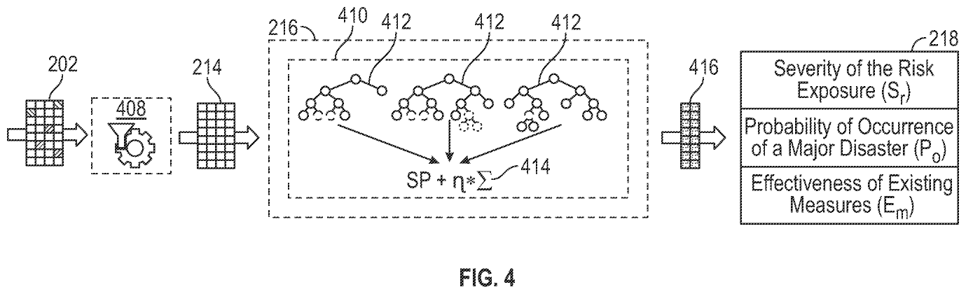

FIG. 4 depicts, generally, the flow of data through a trained gradient boosted trees classifier in accordance with one or more embodiments. As seen, data inputs (202) are received. The data inputs (202) may include historical safety data (204), incident reports (206), operational parameters (208), a safety risk register (210), and maintenance records (212) to be processed by the gradient boosted trees classifier. The data inputs (202) are preprocessed (408) as previously described. The result of the preprocessing is preprocessed data (214) (e.g., normalized data).

The preprocessed data (214) is passed to a ML model (216). In FIG. 4, the ML model (216) is further represented as a gradient boosted trees classifier (410) composed of a plurality of decision trees (412). As such, the preprocessed data (214) is processed by each decision tree (412) and the output of each decision tree is collected, multiplied by the learning rate (η), summed, and added to the SP established during training, forming an ensemble prediction (414). The result of the ensemble prediction (414) is returned as the ML model prediction (416). Depending on the configuration of the gradient boosted trees classifier (410), the model prediction (416) may take various forms. For example, the model prediction (416) may return predictive variables (218) including severity of the risk exposure (Sᵣ) (220), probability of occurrence of a major disaster (P₀) (222) and effectiveness of existing measures (Eₘ) (224). The predictive variables (218) obtained from the model prediction (416) may be directly converted to the REPS (226), as shown in EQ. 1.

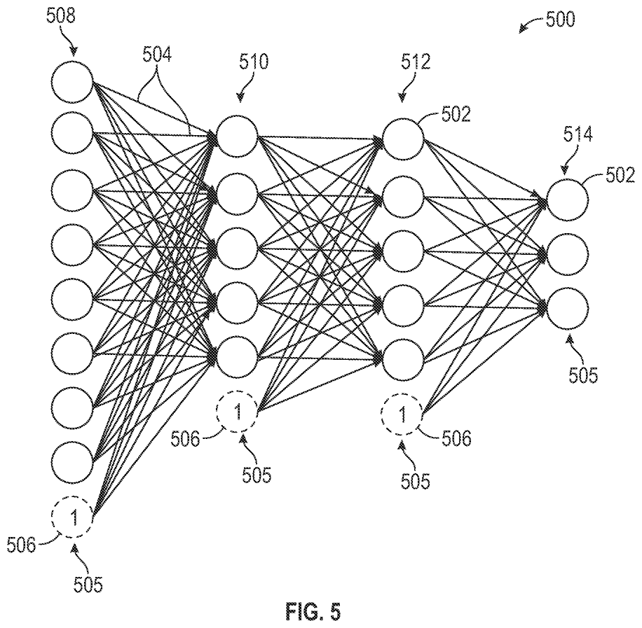

In accordance with one or more embodiments, the ML model (216) discussed herein may be a neural network. A diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer.” Any intermediate layer (510, 512) is usually described as a “hidden layer”. A neural network (500) may have zero or more hidden layers (510, 512) and a neural network (500) with at least one hidden layer (510, 512) may be described as a “deep” neural network or as a “deep learning method.” In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters.” While training a neural network (500), numerical values are assigned to each edge (504). Additionally, every node (502) is associated with a numerical variable and an activation function. Activation functions are not limited to any functional class, but traditionally follow the form

$$A = f ( {\sum }_{i ∈ ( i n com ing )} [ {( node value )}_{i} {( edge value )}_{i} ] ) \qquad Equation ( 13 )$$

where i is an index that spans the set of “incoming” nodes (502) and edges (504) and f is a user-defined function. Incoming nodes (502) are those that, when viewed as a graph (as in FIG. 5), have directed arrows that point to the node (502) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506), displayed in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

As noted, the training procedure for the neural network (500) comprises assigning values to the edges (504). To begin training the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. Recall, that a given data set will be composed of inputs and associated target(s), where the target(s) represent the “ground truth,” or the otherwise desired output. In accordance with one or more embodiments, the input of the neural network are the data inputs (202) (e.g., historical safety data (204), incident reports (206), operational parameters (208), a safety risk register (210), and maintenance records (212)), which may be preprocessed, and the targets are predictive variables (218) (e.g., severity of the risk exposure (220), probability of occurrence of a major disaster (222) and effectiveness of existing measures (224)).

The neural network (500) output is compared to the associated input data target(s). The comparison of the neural network (500) output to the target(s) is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (500) output and the associated target(s). The loss function may also be constructed to impose additional constraints on the values assumed by the edges (504), for example, by adding a penalty term, which may be physics-based, or a regularization term. Generally, the goal of a training procedure is to alter the edge (504) values to promote similarity between the neural network (500) output and associated target(s) over the data set. Thus, the loss function is used to guide changes made to the edge (504) values, typically through a process called “backpropagation.”

While a full review of the backpropagation process exceeds the scope of this disclosure, a brief summary is provided. Backpropagation consists of computing the gradient of the loss function over the edge (504) values. The gradient indicates the direction of change in the edge (504) values that results in the greatest change to the loss function. Because the gradient is local to the current edge (504) values, the edge (504) values are typically updated by a “step” in the direction indicated by the gradient. The step size is often referred to as the “learning rate” and need not remain fixed during the training process. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the neural network (500) will likely produce different outputs. Thus, the procedure of propagating at least one input through the neural network (500), comparing the neural network (500) output with the associated target(s) with a loss function, computing the gradient of the loss function with respect to the edge (504) values, and updating the edge (504) values with a step guided by the gradient, is repeated until a termination criterion is reached. Common termination criteria are: reaching a fixed number of edge (504) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (504) values are no longer intended to be altered, the neural network (500) is said to be “trained”.

While multiple embodiments using different ML models have been suggested, one skilled in the art will appreciate that this process of determining a REPS (226) is not limited to the listed ML models. ML models such as a random forest, support vector machines, or non-parametric methods such as K-nearest neighbors may be readily inserted into this framework and do not depart from the scope of this disclosure.

The process of using the trained ML model (600) “in production” is shown in the flowchart of FIG. 6. As previously stated, in this case, the trained ML model (600) is used to process a received input without having a paired target for comparison. To start, a set of data inputs (202) are received as inputs by the trained ML model (600). The data inputs (202) may be of the same form as the inputs used during training and thus may include historical safety data (204), incident reports (206), operational parameters (208), a safety risk register (210), and maintenance records (212). In accordance with one or more embodiments, the trained ML model (600) outputs the REPS (226).

In accordance with one or more embodiments, the trained ML model (600) is used to process data inputs (202) acquired from a real (non-simulated) well (106). For example, the operational parameters (208) may represent actual surface measurements of pressure, temperature, and flow rate as determined, e.g., by the surface sensing system (134). In such an embodiment, the trained ML model (600) may process its input in real time, or near real time, such that REPS (226) may be determined using only pressure, temperature, and flow rate data.

Embodiments of the present disclosure may provide at least one of the following advantages. As noted, due to the complexity and large volume of data involved, proactively predicting when equipment in the work environment (e.g., the well environment (100)) might need urgent maintenance is generally a difficult task. Further, traditional methods often heavily rely on human judgment for risk assessment, which may be subject to errors, bias, and inconsistencies. By continuously receiving and processing data inputs (202) (e.g., operational parameters (208)) with the trained ML model (600), the oil and gas field equipment (e.g., the choke assembly of FIG. 1) may be operated in an optimal state by prioritizing maintenance operations (612) based on the REPS (226), thus mitigating risk ahead of time and fostering a safer work environment.

In accordance with one or more embodiments, the REPS (226) determined by the trained ML model (600) is used to provide safety recommendations (602). Examples of safety recommendations (602) are shown in FIG. 6. For example, safety recommendations (602) may include hazard identification (604), predictive actions (606), improvement suggestions (608) and trend analyses (610). Hazard identification (604) may include missing or weak barriers with potential for serious consequences. Predictive actions (606) may include predicting when operation, maintenance or engineering interventions are required, consistent with the scenarios unfolding. Improvement suggestions (608) may include recommendations to improve safe barriers and or mitigate future risks. For example, improvement suggestions (608) may include suggesting routine checks and inspections of the equipment (e.g., checking the integrity of the production valves (132)) to identify any potential issues before they lead to equipment failure. Further, trend analyses (610) may include generating trends based on recorded and analyzed events over time to support an effective decision making process. For conciseness, not all safety recommendations (602) are enumerated in FIG. 6. However, one with ordinary skill in the art will recognize that many alterations to the safety recommendations (602) of FIG. 6 may be made without departing from the scope of this disclosure.

Keeping with FIG. 6, once the safety recommendations (602) have been determined, maintenance operations (612) are automatically performed on equipment (e.g., the choke assembly of FIG. 1) in the work environment (e.g., the well environment (100)). In general, the higher the REPS (226) the higher the chance of failure, and the trained ML model (600) may highlight areas for immediate action accordingly. In other words, as previously stated, maintenance operations (612) are prioritized based on the REPS (226), and corrective actions are automatically carried out on the equipment based on this determination. Examples of maintenance operations (612) may include, but are not limited to, repairing or replacing faulty components and scheduling maintenance activities. In another embodiment of the present invention, maintenance operations (612) may include transmitting one or more commands to a control system (e.g., the well control system (126)) to adjust, automatically, one or more operational parameters (e.g., choke assembly parameters). By continuously adjusting the operational parameters across the oil and gas field the equipment (e.g., the choke assembly of FIG. 1) may be operated in an optimal state, greatly reducing the periods of production with shutdowns and interruptions. This, in turn, enhances hydrocarbon (i.e., oil and gas) production and prolongs the lifetime of the equipment.

The REPS (226) may also automatically trigger maintenance operations (612) based on equipment condition, where maintenance operations (612) are performed when certain indicators show signs of decreasing performance. This involves, for example, monitoring the condition of the equipment in real time, or near real time, and automatically performing maintenance operations (612) based on the current state of the equipment. The condition of the equipment could be assessed using various sensor readings such as gas flow rate, pressure, and temperature as determined, e.g., by the surface sensing system (134). In one or more embodiments, a user determines a threshold, and the REPS is continuously compared to the threshold. The REPS that are equal or higher than the threshold raise a flag that the equipment is likely to fail. Alternatively, the REPS that are lower than the threshold do not raise a flag, and the process continues to operate without interruptions.

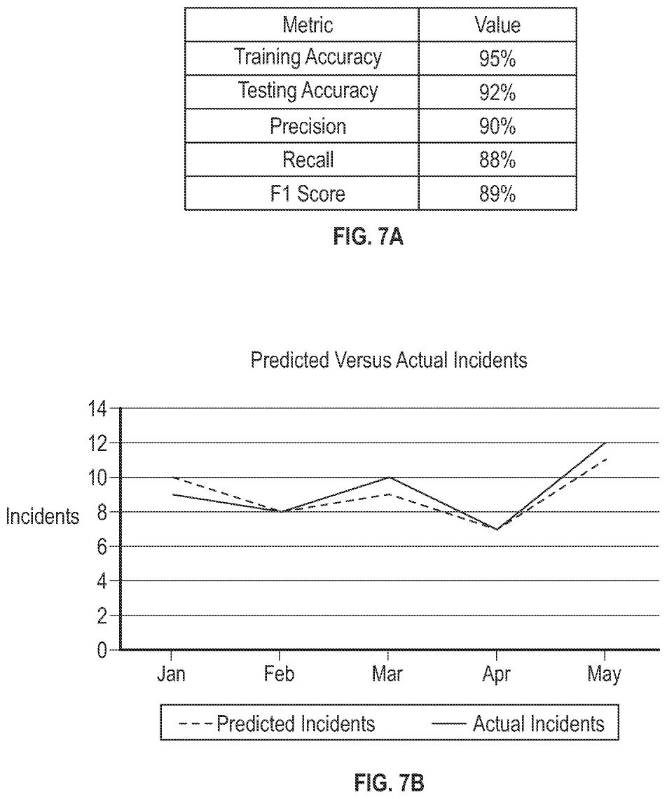

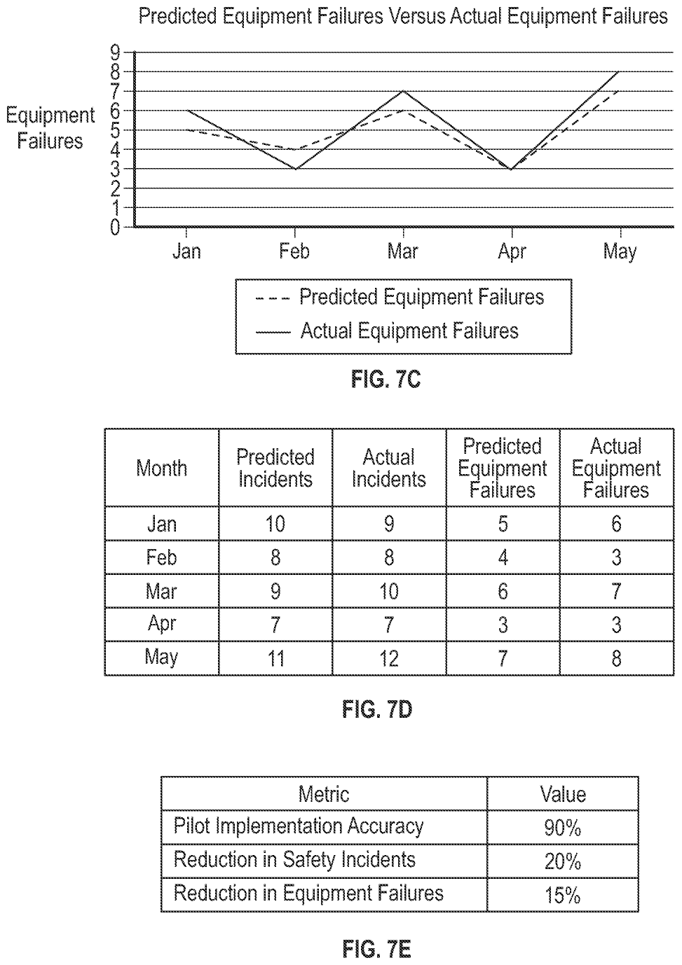

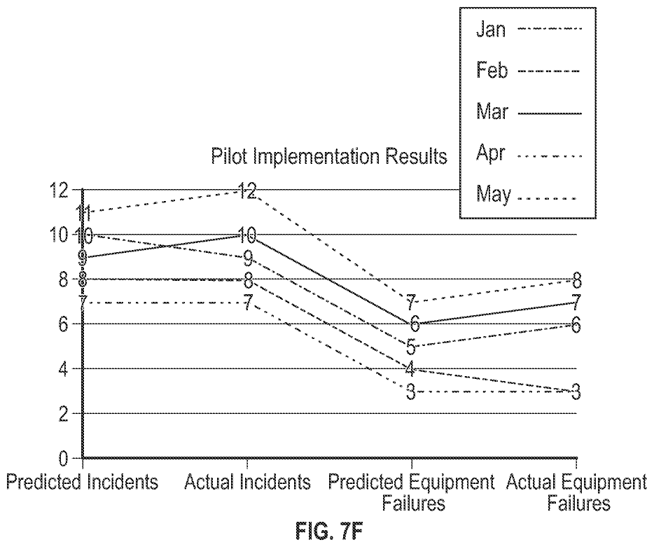

As a concrete example, the workflow of FIG. 6 was implemented in a manufacturing plant to predict equipment failures and safety incidents. FIG. 7A shows the performance of the ML model during the training and testing phases. The high accuracy, precision, recall, and F1 score indicate that the model is performing well at predicting equipment failures and safety incidents. FIG. 7B-7D show, in greater detail, the results of the pilot implementation of the ML model. Specifically, FIG. 7B compares the number of incidents predicted by the ML model to the actual number of incidents that occurred each month. FIG. 7C compares the number of equipment failures predicted by the ML model to the actual number of equipment failures that occurred each month. The close match between the predicted and actual numbers, as shown in FIG. 7D, indicates that the system is effective at predicting these events. FIG. 7E shows the evaluation results of the pilot implementation. The high accuracy indicates that the system performed well in the real-world setting. The reductions in safety incidents and equipment failures suggest that the system helped improve safety and operational efficiency in the manufacturing plant. The number of predicted and actual incidents and equipment failures for each month during the pilot implementation of the ML model are summarized in the line chart of FIG. 7F.

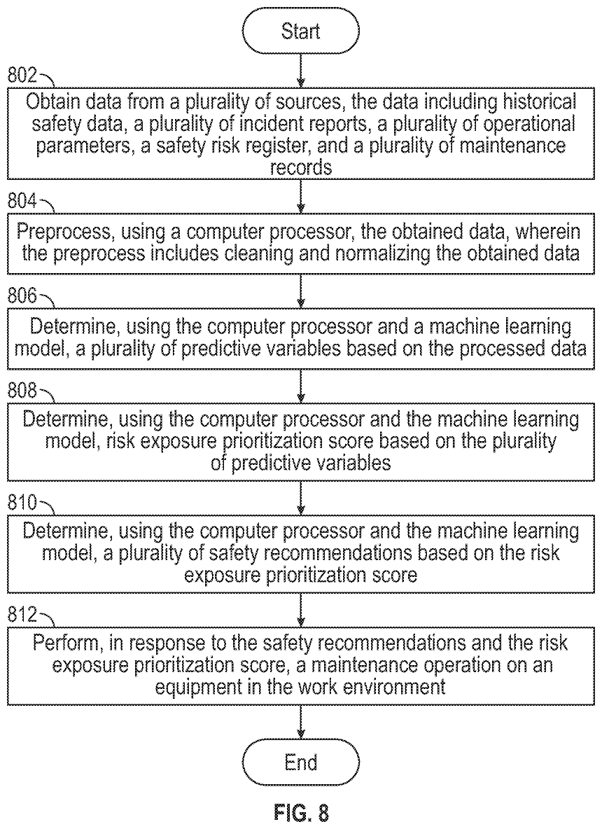

FIG. 8 depicts a method for safety management and risk assessment in a work environment, in accordance with one or more embodiments. In Block 802, data inputs (202) are obtained from a plurality of sources. The plurality of sources includes a plurality of internal and external databases, a plurality of sensors, a plurality of manual reports, a plurality of distributed control systems, and a plurality of engineering workstations.

In Block 802, the sensor readings may include, at least, data about pressure, temperature, flow rate, and vibration. The sensors may be used for sensing characteristics of the rig (101), such as bit depth, hole depth, drilling fluid flow, hook load, rotary speed, etc. During drilling operation of the well (106), the sensor readings may include mud properties, drill volume and penetration rates, formation characteristics, etc. In one or more embodiments, the flow rate is measured by a flow rate sensor (139). The sensor readings may be obtained using specialized tools such as, as least, thermometers, pressure gauges, and flowmeters (e.g., venturi meters, turbine meters, ultrasonic meters, electromagnetic meters, etc.).

In Block 802, the data inputs (202) may include historical safety data (204), a plurality of incident reports (206), a plurality of operational parameters (208), a safety risk register (210), and a plurality of maintenance records (212). For example, historical safety data (204) may include past records of safety related incidents and incident reports (206) may include detailed accounts of previous incidents. Operational parameters (208) may include process upsets, system alarms, choke assembly parameters, pressure and temperature data (e.g., pressure and temperature data as determined by the plurality of sensors). In one or more embodiments, the incident reports (206), operational parameters (208) and maintenance records (212) may be obtained in real time or near real time. In other embodiments, the incident reports (206), operational parameters (208) and maintenance records (212) may be obtained sequentially or immediately after drilling operations are performed. Further, a safety case register (210), defined as a database with information relevant to a hazard, may include hazard and operability studies, safety integrity levels, quantitative risk assessments, an operations integrity management system, and safety regulations and standards. Maintenance records (212) may include information on equipment maintenance and inspections.

In Block 804, the data is preprocessed, using a computer (902) processor, to obtain preprocessed data (214). Preprocessing comprises, at a minimum, altering the data inputs (202) so that it is suitable for use with ML models. For example, preprocessing may include numericizing categorical data or removing data entries with missing values. Other typical preprocessing methods are normalization and subsampling. Subsampling is a method that reduces data size by selecting a subset of the original data. One with ordinary skill in the art will recognize that a myriad of preprocessing methods beyond numeration, removal of modelling data entries with missing values, normalization, and subsampling exists. Descriptions of a select few preprocessing methods herein do not impose a limitation on the preprocessing steps encompassed by this disclosure.

In Block 806, a plurality of predictive variables (218) based on, at least, the preprocessed data (214) is determined using the computer (902) processor and the trained ML model (600). ML model types may include, but are not limited to, K-means clustering, K-nearest neighbors, neural networks, logistic regression, random forests, generalized linear models, and Bayesian regression. Also, ML encompasses model types that may further be categorized as “supervised”, “unsupervised”, “semi-supervised”, or “reinforcement” models. Predictive variables (218) include severity of the risk exposure (220), probability of occurrence of a major disaster (222) and effectiveness of existing measures (224).

In Block 808, a REPS (226) based on, at least, the plurality of predictive variables (218) is determined using the computer (902) processor and trained ML model (600). The REPS (226) may be directly determined from the predictive variables (218), as shown in Equation (1).

In Block 810, a plurality of safety recommendations (602) based on, at least, the REPS (226) is determined using the computer (902) processor and trained ML model (600). Safety recommendations (602) may include hazard identification (604), predictive actions (606), improvement suggestions (608) and trend analyses (610).

In Block 812, maintenance operations (612) on an equipment (e.g., the choke assembly of FIG. 1) in the work environment (e.g., the well environment (100)) based on, at least, the safety recommendations (602) and the REPS (226) are performed. Maintenance operations (612) may be prioritized based on the REPS (226) and corrective actions are automatically carried out on the equipment based on this determination. Maintenance operations (612) may include, for example, transmitting one or more commands to a control system (e.g., the well control system (126)) to adjust, automatically, one or more operational parameters (e.g., choke assembly parameters).

Embodiments may be implemented on a computer system. FIG. 9 is a block diagram of a computer system (902) used to provide computational functionalities associated with described algorithms, methods, functions, processes, flows, and procedures as described in the instant disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. For example, the ML model (216) may be implemented on an edge computing device to quickly provide REPS (226) and automatically perform maintenance operations (612).

Additionally, the computer (902) may include a computer that includes an input device, such as a keypad, keyboard, touch screen, or other device that may accept user information, and an output device that conveys information associated with the operation of the computer (902), including digital data, visual, or audio information (or a combination of information), or a GUI.

The computer (902) may serve in a role as a client, network component, a server, a database or other persistency, or any other component (or a combination of roles) of a computer system for performing the subject matter described in the instant disclosure. In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) may receive requests over network (930) from a client application (for example, executing on another computer (902) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) may communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that may be connected to the network (930). The memory may be a non-transitory computer readable medium. For example, memory (906) may be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) may be external to the computer (902).

The application (907) is an algorithmic software engine providing functionality according to particular needs, desires, or particular implementations of the computer (902), particularly with respect to functionality described in this disclosure. For example, application (907) may serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) may be external to the computer (902).

There may be any number of computers (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for safety management and risk assessment in a work environment, the method comprising:
obtaining data from a plurality of sources, the data including historical safety data, a plurality of incident reports, a plurality of operational parameters, a safety risk register, and a plurality of maintenance records;
preprocessing, using a computer processor, the obtained data, wherein the preprocessing includes cleaning and normalizing the obtained data;
determining, using the computer processor and a machine learning model, a plurality of predictive variables based on the preprocessed data;
determining, using the computer processor and the machine learning model, risk exposure prioritization score based on the plurality of predictive variables;
determining, using the computer processor and the machine learning model, a plurality of safety recommendations based on the risk exposure prioritization score; and
performing, in response to the safety recommendations and the risk exposure prioritization score, a maintenance operation on an equipment in the work environment.

2. The method of claim 1, wherein the plurality of sources includes a plurality of internal and external databases, a plurality of sensors, a plurality of manual reports, a plurality of distributed control systems, and a plurality of engineering workstations.

3. The method of claim 1, wherein the historical safety data includes a plurality of past records of safety related incidents.

4. The method of claim 1, wherein the plurality of operational parameters includes pressure and temperature data.

5. The method of claim 1, wherein the machine learning model includes a gradient boosting regressor, a neural network, subsampling, and regularization terms.

6. The method of claim 1, wherein the plurality of predictive variables includes severity of the risk exposure, probability of occurrence of a major disaster, and effectiveness of existing measures.

7. The method of claim 1, wherein the plurality of safety recommendations includes hazard identification, a plurality of predictive actions, a plurality of improvement suggestions, and a plurality of trend analyses.

8. The method of claim 1, wherein the maintenance operations are prioritized based on the risk exposure prioritization score.

9. The method of claim 1, further comprising:
selecting, using the computer processor, a machine learning model type and a plurality of hyperparameters;
evaluating, using the computer processor and a loss function, the selected machine learning model based on its predictive performance on a desired target output;
adjusting, using the computer processor and the loss function, the plurality of hyperparameters; and
re-training, using the computer processor, the selected machine learning model with the adjusted plurality of hyperparameters.

10. The method of claim 1, wherein determining the risk exposure prioritization score using a neural network comprises:
generating, using the computer processor, relationships between the data and a target initial risk exposure prioritization score by adjusting weights and biases of neurons in the neural network; and
determining, using the computer processor, an initial equipment failure probability based on the generated relationships.

11. The method of claim 1, wherein the maintenance operation comprises adjusting operational parameters.

12. A non-transitory computer readable medium storing instructions executable by a computer processor, the instructions comprising functionality for:
obtaining data from a plurality of sources, the data including historical safety data, a plurality of incident reports, a plurality of operational parameters, a safety risk register, and a plurality of maintenance records;
preprocessing the obtained data, wherein the preprocessing includes cleaning and normalizing the obtained data;
determining, using a machine learning model, a plurality of predictive variables based on the preprocessed data;
determining, using the machine learning model, risk exposure prioritization score based on the plurality of predictive variables;
determining, using the machine learning model, a plurality of safety recommendations based on the risk exposure prioritization score; and
performing, in response to the safety recommendations and the risk exposure prioritization score, a maintenance operation on an equipment.

13. The non-transitory computer readable medium of claim 12, wherein the maintenance operations are prioritized based on the risk exposure prioritization score.

14. The non-transitory computer readable medium of claim 12, wherein the machine learning model includes a gradient boosting regressor, a neural network, subsampling, and regularization terms.

15. The non-transitory computer readable medium of claim 12, further comprising:
selecting, using the computer processor, a machine learning model type and a plurality of hyperparameters;
evaluating, using the computer processor and a loss function, the selected machine learning model based on its predictive performance on a desired target output;
adjusting, using the computer processor and the loss function, the plurality of hyperparameters; and
re-training, using the computer processor, the selected machine learning model with the adjusted plurality of hyperparameters.

16. The non-transitory computer readable medium of claim 12, wherein determining the risk exposure prioritization score using a neural network comprises:
generating, using the computer processor, relationships between the data and a target initial risk exposure prioritization score by adjusting weights and biases of neurons in the neural network; and
determining, using the computer processor, an initial equipment failure probability based on the generated relationships.

17. A system comprising:
a plurality of sensors; and
a safety management and risk assessment system comprising a computer processor, wherein the safety management and risk assessment system is coupled to the plurality of sensors, the safety management and risk assessment system comprising functionality for:
obtaining data from the plurality of sensors, the data including historical safety data, a plurality of incident reports, a plurality of operational parameters, a safety risk register, and a plurality of maintenance records;
preprocessing the obtained data, wherein the preprocessing includes cleaning and normalizing the obtained data;
determining, using a machine learning model, a plurality of predictive variables based on the preprocessed data;
determining, using the machine learning model, risk exposure prioritization score based on the plurality of predictive variables;
determining, using the machine learning model, a plurality of safety recommendations based on the risk exposure prioritization score; and
performing, in response to the safety recommendations and the risk exposure prioritization score, a maintenance operation on an equipment.

18. The system of claim 17, wherein the maintenance operations are prioritized based on the risk exposure prioritization score.

19. The system of claim 17, wherein the machine learning model includes a gradient boosting regressor, a neural network, subsampling, and regularization terms.

20. The system of claim 17, wherein determining the risk exposure prioritization score using a neural network comprises:
generating, using the computer processor, relationships between the data and a target initial risk exposure prioritization score by adjusting weights and biases of neurons in the neural network; and
determining, using the computer processor, an initial equipment failure probability based on the generated relationships.
